(19) United States
(12) Patent Application Publication
(10) Pub. No.: US 2024/0341296 A1
(43) Pub. Date: Oct. 17, 2024

(54) WILDLIFE EXCLUSION DEVICE

(71) Applicant: Kritter Catchers LLC, Nutley, NJ (US)

(72) Inventors: Claire Dotoli, Nutley, NJ (US); Killian Ramsthaler, Nutley, NJ (US)

(21) Appl. No.: 18/629,109

(22) Filed: Apr. 8, 2024

Related U.S. Application Data
(60) Provisional application No. 63/459,427, filed on Apr. 14, 2023.

(51) Int. Cl. A01M 29/30

(52) U.S. Cl. CPC A01M 29/30

(57) ABSTRACT

An exclusion device has a tunnel with opposite first and second ends. Mounting tabs project out from the first end of the tunnel. Outer barbs project from the second end of the tunnel and are bent relative to the tunnel so that the outer barbs converge toward one another at farther distances from the tunnel. The outer barbs are tapered toward ends remote from the tunnel. Intermediate barbs have base ends unitary with the tunnel at locations intermediate the first and second ends of the tunnel. Each intermediate barb is tapered to narrower dimensions at locations farther from the base end of the respective intermediate barb and at locations closer to the second end of the tunnel. The intermediate barbs are bent into the tunnel. The mounting tabs are mounted to a structure so that the tunnel leads from an animal opening. Thus the animal can escape but cannot re-enter.

### CROSS REFERENCE TO RELATED APPLICATION

This application claims priority to U.S. Provisional Patent Appl. No. 63/459,427, filed Apr. 14, 2023, the entire disclosure of which is incorporated herein by reference.

### BACKGROUND OF THE INVENTION

Field of the Invention The invention relates to a device to prevent one or more species of animals from accessing a structure in which the animals are not wanted.

Related Art Most animals seek nesting locations that protect the animals from the elements and from predators. Structures that are built by human beings and that are inhabited or used by human beings can provide ideal nesting locations for animals. The animal merely needs an access location on the perimeter of the structure to provide ingress and egress to and from the interior of the structure. The animal then will follow a path within the structure to an unobtrusive nesting location in the structure. The animals use a well-developed sense of smell to return to the same access location on the external perimeter of the structure and then will follow a safe trusted route to the same nesting location inside the structure. Animals that are known to seek nesting locations within buildings include mice, rats, chipmunks, squirrels, raccoons and skunks to name a few.

Traps and poisons that kill animals have the various drawbacks. For example, traps can be tripped by small children or pets, and poisons can be consumed by small children or pets. Additionally, the environmental impact caused by many poisons is uncertain, at best. Some traps are designed to retain an animal without killing the animal. However, the trap and an animal captured therein must be brought by a human being to a location where the animal can be released. That location must be sufficiently far from the structure where the animal was caught to ensure that the animal does not find its way back to the building and the nest.

Some devices are designed to be affixed to a structure at a location where the animal enters and leaves the structure. These devices are configured to allow the animal to leave the structure, but are intended prevent the animal from reentering. An example of one such device is shown in U.S. Pat. No. D833,567, and the blank for forming such a device is shown in U.S. Pat. No. D829,300. The radially extending tabs shown in. U.S. Pat. No. D833,567 are secured to an outer surface of a building wall so that the cylindrical structure of U.S. Pat. No. D833,567 projects perpendicularly from the wall at a location aligned with an identified access location that is used by the animal. The pointed projections at the end of the cylindrical structure remote from the tabs can be deformed resiliently by an animal that is within the building when the device is installed. Thus, the animal can escape from the building merely by deforming the pointed projections outward. Those projections will return resiliently toward one another when the animal leaves. The pointed projections are intended to prevent the animal from re-entering the building structure via the cylindrical portion of the device. However, animals have a strong desire to return to their nesting location in the building structure. Additionally, most animals are very strong for their size and the design shown in U.S. Pat. No. D833,567 allows the animal to apply considerable leverage to the pointed projections from an exterior location. Thus, the pointed projections can be deformed outward beyond the point where they resiliently return, thereby leaving a permanent opening for both ingress and egress by the animal. Additionally, sharply pointed projections can impale the animal, thereby leading to a slow painful death or leaving a severely injured animal to be dealt with by the home owner or the professional who has been retained by the home owner to merely keep the animal away from the dwelling. Most home owners do not want to inflict suffering on the animal.

An object of the invention is to provide an exclusion device configured to prevent an animal from deforming the pointed projections and to ensure that the animal cannot reenter the building.

Another object of the invention is to facilitate the formation of the exclusion device.

A further object of the invention is to increase the strength of the exclusion device.

### SUMMARY OF THE INVENTION

This disclosure relates to an exclusion device that can be mounted to an exterior of a building at a location where animals are known to enter and leave the building. The device has a generally tubular tunnel with opposite first and second longitudinal ends. The tunnel can be substantially cylindrical, but also can have a non-cylindrical tubular shape. For example, a cross-section of the tunnel can be square, hexagonal or octagonal or other polygonal shape. Mounting tabs project out from the first end of the tubular tunnel. The mounting tabs may be aligned radially to the longitudinal axis of the tunnel and may lie in a single plane perpendicular to the longitudinal axis of the tunnel. Areas of the tabs remote from the tubular tunnel may have openings to permit one or more of the tabs to be affixed to a surface of the building structure so that the tubular tunnel projects substantially perpendicularly away from the wall of the structure. Importantly, the tabs are mounted to a location on the structure so that the first end of the tubular tunnel surrounds an access opening to the structure with the first end of the tubular structure abutting the external wall of the structure or positioned very close to the external wall of the structure.

A plurality of outer barbs are cantilevered from the second end of the tubular tunnel. Each outer barb may initially be substantially coextensive with the side wall of the tubular tunnel. Additionally, each outer barb may be substantially triangular so that each outer barb tapers toward the end of the respective outer barb remote from the first end of the tubular tunnel. The outer barbs need not have a sharp point at the tapered end. The outer barbs initially will extend substantially parallel to the longitudinal axis of the tubular tunnel. However, the outer barbs then are bent toward the axis of the tubular tunnel so that the tapered ends of the outer barbs converge at a location beyond the first end of the tubular tunnel.

The device further has a plurality of intermediate barbs cantilevered from locations between the opposite first and second ends of the tubular tunnel. Each intermediate barb has a wide base integral with the tubular tunnel and a pointed tip remote from the base. The intermediate barbs initially are substantially coextensive with the tubular side wall of the tunnel. However, the intermediate barbs then are deformed inward toward the longitudinal axis of the tubular tunnel. Thus, the tapered ends of the intermediate barbs are at or near the longitudinal axis of the tubular tunnel.

Side tabs project from a side edge of the metal blank that forms the device and can be inserted into slots formed in an opposed side edge of the blank to hold the blank into the finished tubular shape.

The device is used by affixing the mounting tabs to the external surface of the building so that the tunnel projects outward from the building and at a position surrounding the access opening to the building. Ideally, the device is mounted when the animals are not present in the building. However, animals that are within the building when the device is installed can escape from the building merely by advancing through the tunnel from the first end toward the second end. The intermediate barbs and the outer barbs are sufficiently deformable to allow the animal to pass through the tunnel, and the barbs then will resiliently return toward their position aligned obliquely to the longitudinal axis of the device. An animal may try to reenter the building by deforming the outer barbs resiliently outward. However, the animal will be unable to apply the required leverage to deform the intermediate barbs outwardly beyond their resilient limits. More particularly, an animal that may successfully deform the outer barbs outwardly a sufficient amount to partly enter the second end of the tunnel will not be in a position to exert sufficient leverage for permanently deforming the inner barbs outwardly. As a result, the animal will be forced to retreat and will be unable to re-enter the building.

### BRIEF DESCRIPTION OF THE DRAWINGS

FIG. 1 is a perspective view of a blank for forming an exclusion device in accordance with an embodiment of this disclosure.

FIG. 2 is a rear perspective view of the exclusion device formed from the blank shown in FIG. 1.

FIG. 3 is a front perspective view of the exclusion device of FIG. 2.

FIG. 4 is a top plan view of the exclusion device.

FIG. 5 is a bottom plan view of the device shown in FIG. 2.

FIG. 6 is a rear elevational view of the exclusion device.

FIG. 7 is a front elevational view of the exclusion device.

FIG. 8 is a right side elevational view of the exclusion device.

FIG. 9 is a left side elevational view of the exclusion device.

### DETAILED DESCRIPTION

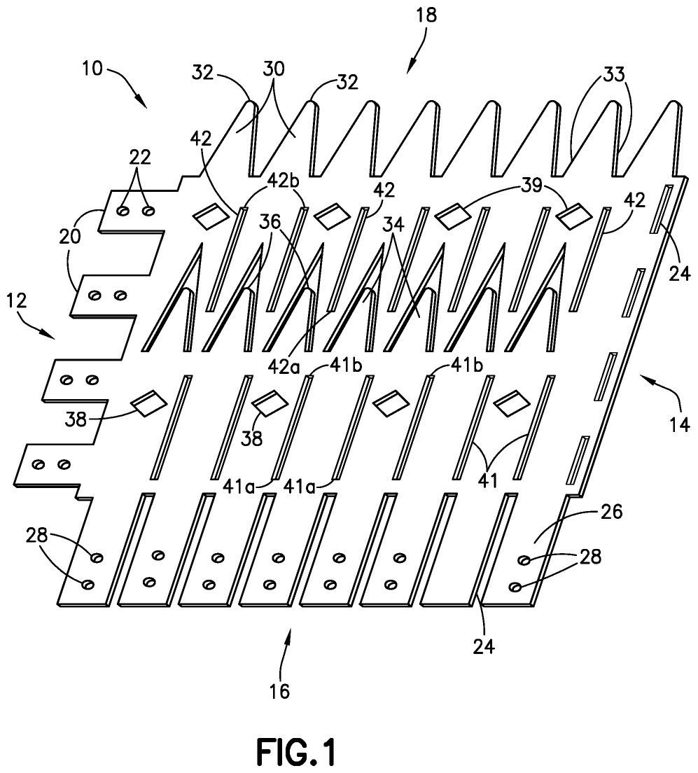

A blank for forming an exclusion device in accordance with an embodiment of the invention is identified generally by the numeral 10 in FIG. 1. The blank is formed from a planar sheet of metal and includes opposite first and second sides 12 and 14, and first and second ends 16 and 18. The first side 12 is cut to define side tabs 20 projecting from the first side 12 of the blank 10. Each side tab 20 includes detents or apertures 22. Areas of the blank 10 inward from the second side include slots 24 corresponding in number and shape to the side tabs 20. As explained further below, the blank 10 can be formed into a generally tubular shape and retained in that shape by inserting the side tabs 20 into the corresponding slots 24. The apertures 22 in the side tabs 20 can be engaged by a tool, such as a screwdriver of point pliers to deform the side tabs 20. Embodiments that have one or more detents instead of or in addition to the apertures 20 can rely upon the detents engaging parts of the blank 10 adjacent the respective slots 24 to hold the blank 10 in the tubular configuration.

The first end 16 of the blank 10 is formed with mounting slots 24 extending from the first end 16 toward the second end 18. Mounting tabs 26 are defined between adjacent mounting slots 24. Each mounting tab 26 of this embodiment is substantially rectangular and is formed with holes 28 extending entirely through the respective mounting tab 26. Nails or screws can be passed through at least some of the holes to mount the extrusion device on a building, as explained herein.

The second end 18 of the blank 10 is cut to form outer barbs 30. Each outer barb 30 converges to a preferably rounded point 32 at the end of the respective barb 30 opposite the first end 16 of the blank 10. Additionally, substantially V-shaped recesses 33 are formed between adjacent outer barbs 30. In this embodiment, a total of eight outer barbs 30 are provided. However, more or fewer outer barbs 30 can be provided in other embodiments. Alternate embodiments can have sharply pointed barbs.

Portions of the blank 10 between the first and second ends 16 and 18 are formed to define intermediate barbs 34. Each intermediate barb 34 has a tapered end 36 directed toward the second end 18 of the blank 10. The intermediate barbs 34 of this embodiment correspond in number to the outer barbs 30 and are at positions so that each intermediate barb 34 aligns with one of the outer barbs 30 along a direction extending parallel to the second side edge 14 of the blank 10. The tapered ends of the intermediate barbs 34 are rounded in this preferred embodiment. However, sharp points can be provided.

First openings 38 are formed through the blank 10 at positions between the intermediate barbs 34 and the first end 16 of the blank 10. Second openings 39 are formed through the blank 10 at positions between the intermediate barbs 34 and the second end 18 of the blank 10. In this embodiment, the openings 38, 39 are substantially square or diamond shaped and align with an aligned pair of intermediate barbs 34 and outer barbs 30. The openings 38 and 39 enable animals to see the intermediate barbs 34 and are intended to discourage animals from attempting an entry into the exclusion device formed from the blank 10. The particular locations and shapes of the openings 38 and 39 can vary from those shown in FIG. 1.

First fold line slots 41 and second fold line slots 42 are formed through the blank 10 and are positioned so that: the first fold line slots 41 are parallel with one another; the second fold line slots 42 are parallel to one another; and each first fold line slot is colinear with one of the second fold line slots 42 to define pairs of colinear fold line slots 41, 42. The first fold line slots 41 are closer to the first end 16 of the blank 10 and the second fold line slots 18 are closer to the second end 18 of the blank 10. Each pair of aligned fold line slots 41, 42 align respectively with the forming slots 24 at the first end 16 of the blank 10 and with the V-shaped recess 33 between adjacent outer barbs 30 at the second end 18 of the blank. Each first fold line slot 41 has a first end 41a aligned with and spaced from a corresponding forming slot 24 and a second end 41b that is closer to the intermediate barbs 34. Thus, the first fold line slots 41 do not extend into the spaces between the intermediate barbs 34. Each second fold line slot 42 has a first end 42a in a space between two adjacent intermediate barbs 34 and spaced from the second end 41b of the corresponding first fold line slot 41. Each second fold line slot 42 also has a second end 42b spaced from the V-shaped recess 33 between adjacent outer barbs 30. The pairs of colinear first and second fold line slots 41 and 42 facilitate bending the blank 10 to form parallel linear fold lines 44 and side panels 46 between adjacent fold lines 44, as explained below

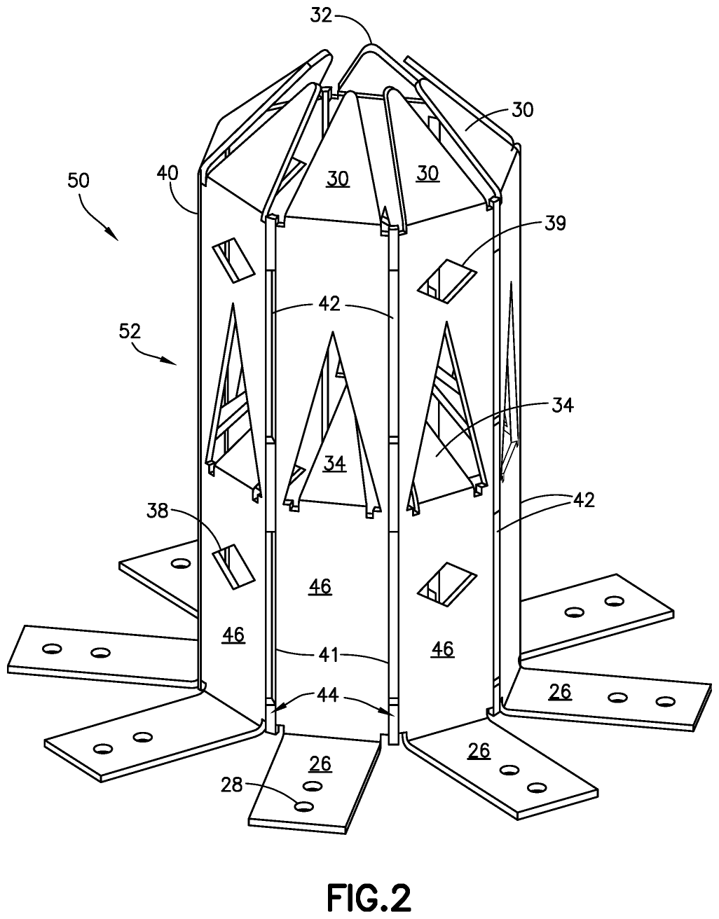

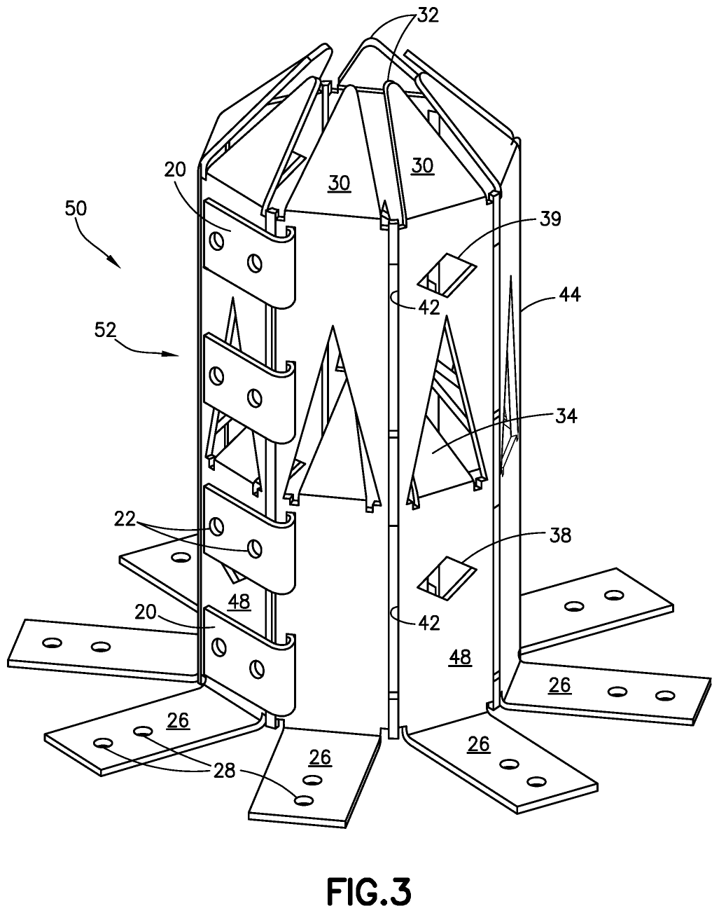

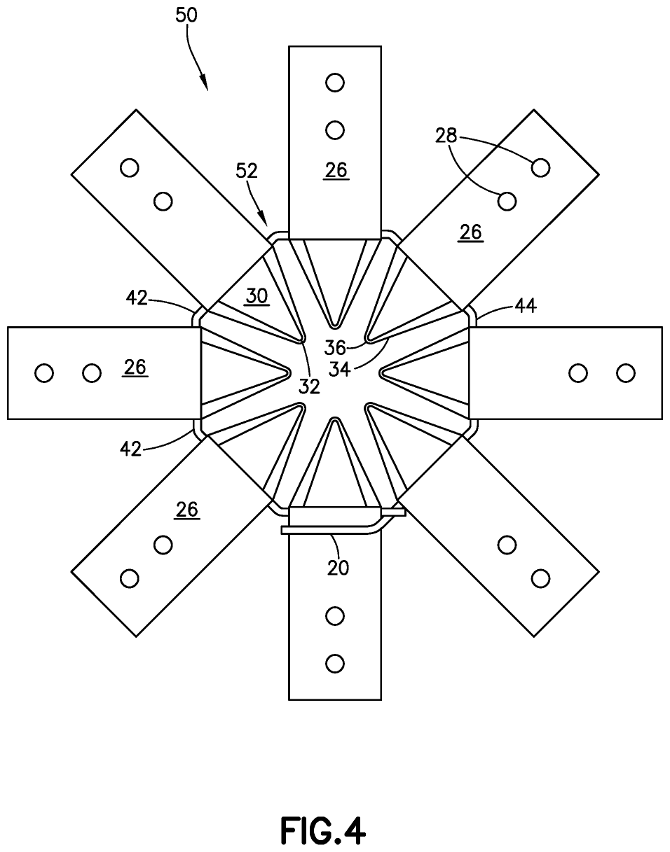

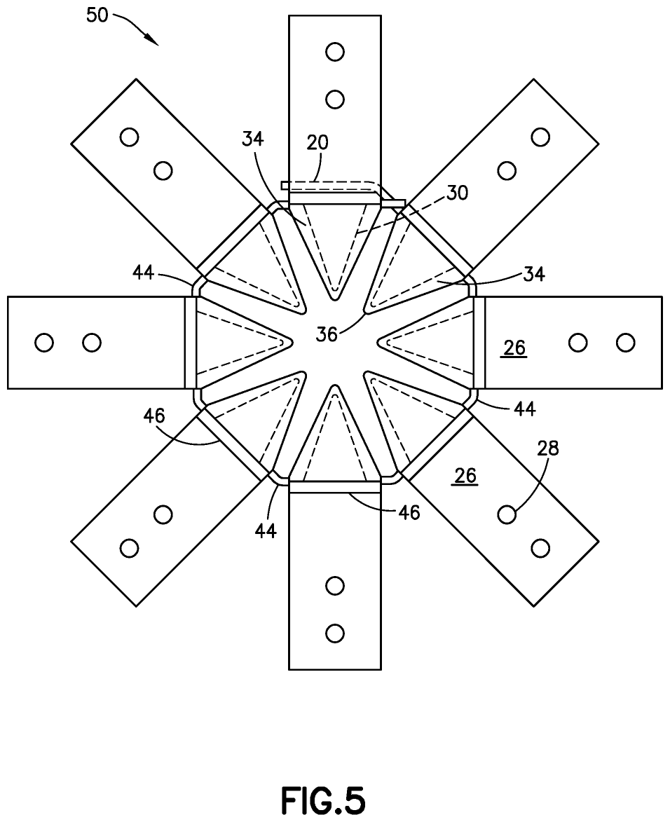

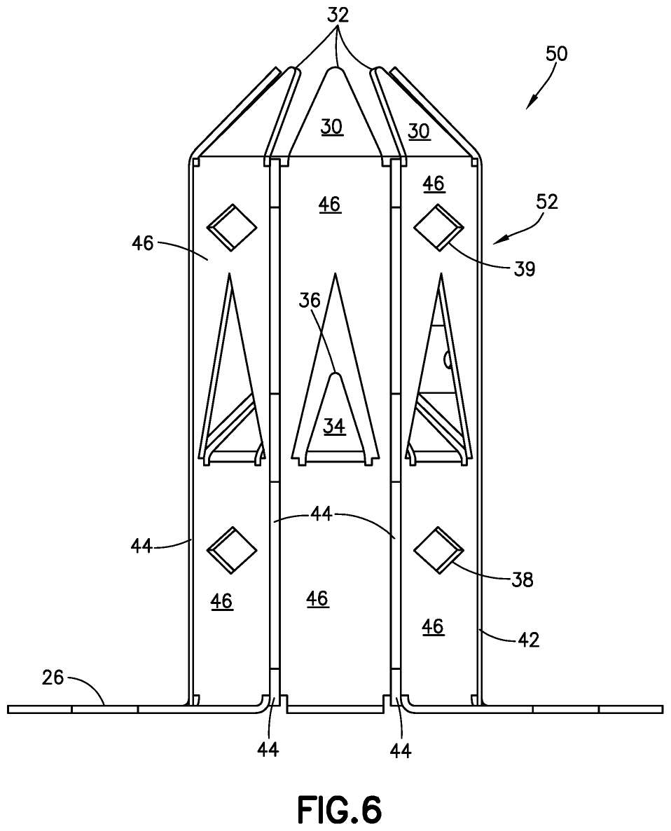

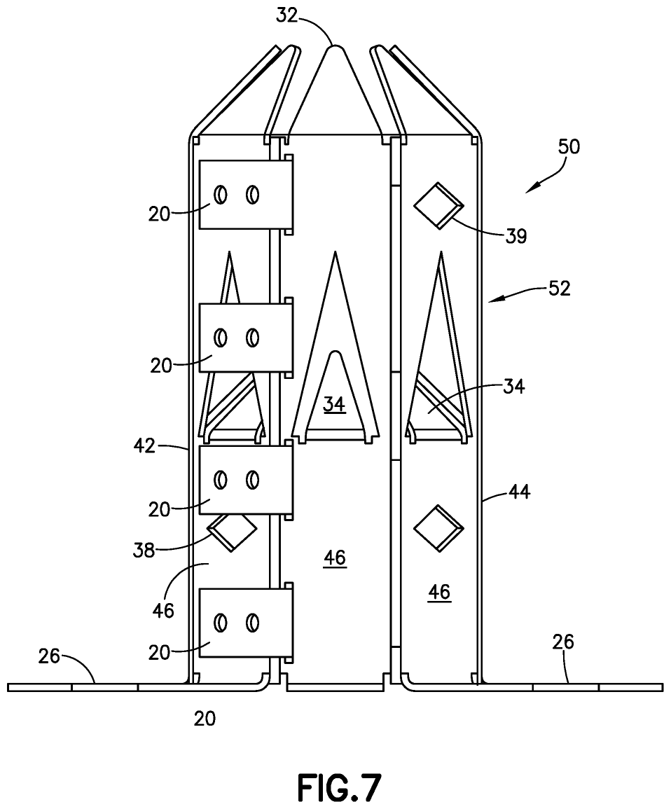

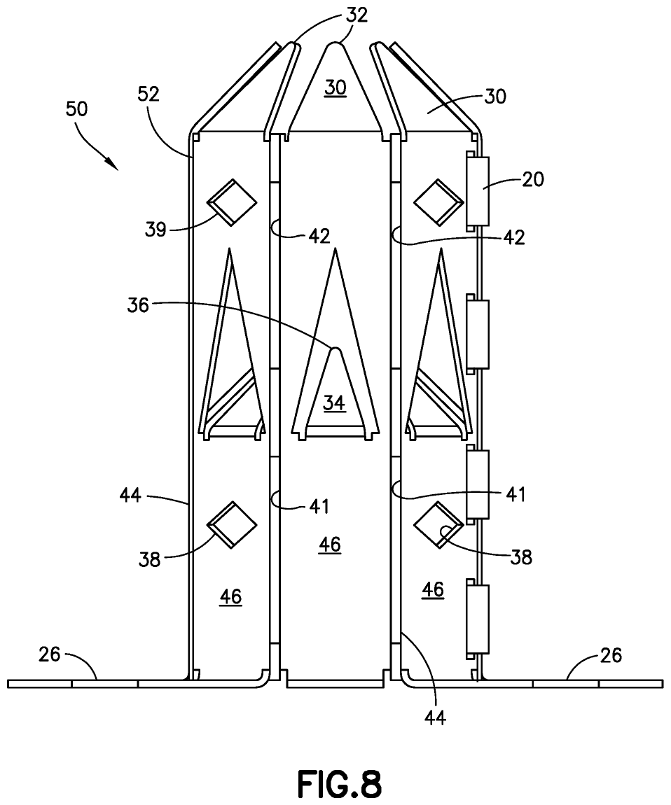

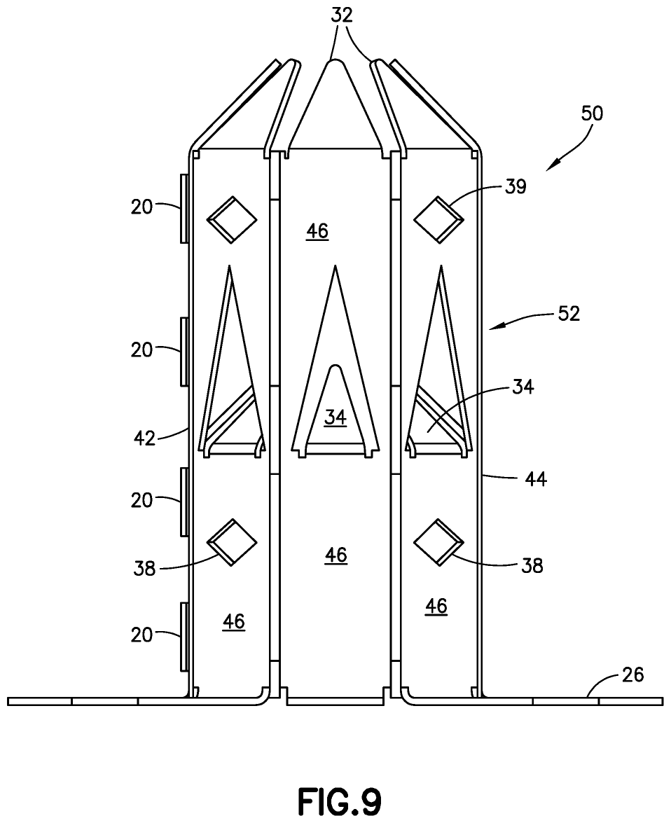

The blank 10 is formed into the exclusion device 50 illustrated in FIGS. 2-9. More particularly, the exclusion device 50 is formed by folding the blank 10 about fold lines 44 that extend substantially parallel to one another in directions extending between the first and second ends 16 and 18 of the blank 10 and parallel to the first and second sides 12 and 14 of the blank 10. Each fold line 44 encompasses one first fold line slot 41 and one second fold line slot 42. The respective pairs of first and second fold line slots 41 and 42 facilitate forming the well-defined fold lines 44. Thus, the exclusion device 50 forms a substantially octagonal tubular tunnel 52, with the fold lines 44 forming longitudinally extending corner regions of the octagonal tubular tunnel 52 and with areas of the blank 10 between the fold lines 44 forming the side panels 46 of the octagonal tubular tunnel 52. Each pair of aligned fold line slots 40, 46 enable the fold lines 44 to be formed with greater ease and precision to provide a polygonal tunnel 52 with greater strength than a tunnel with a circular cross-section. The blank 10 is retained in the tubular shape shown in FIGS. 2-9 by inserting the side tabs 20 into the corresponding slots 24. In some embodiments, the areas of the blank 10 adjacent the slots 24 will be engaged between the two detents on the respective side tab 20 to prevent the tunnel 44 from collapsing too much and to prevent the tunnel 52 from opening, thereby retaining the octagonal tubular shape of the tunnel 52. In the illustrated embodiment, however, the side tabs 20 are merely folded back after insertion through the slots 24 and lie adjacent the outer surface of the tunnel 52.

The mounting tabs 26 then are folded outwardly into a substantially perpendicular alignment with the corresponding side panels 46 from which each respective mounting tab 26 extends. The bent mounting tabs 28 will lie substantially in a common plane that is perpendicular to a longitudinal axis defined by the octagonal tubular tunnel 52.

The outer barbs 30 then are bent inward from the respective side panel 46 and toward the longitudinal axis of the tunnel 52. Thus, the outer barbs 30 will converge toward one another so that the tapered or pointed ends 32 are near one another and near the longitudinal axis of the tunnel 52.

The intermediate barbs 34 similarly are bent inward from the respective side panel 46 and toward the longitudinal axis of the tunnel 52. Thus, the tapered or pointed ends 36 of the intermediate barbs 34 will converge toward one another so that the tapered or pointed ends 36 are near one another and near the longitudinal axis of the tunnel 52.

The exclusion device 50 is used by affixing the mounting tabs 24 to an external surface of a building so that the tunnel 44 projects away from the building and at a position to surround an animal access opening into the building. The mounting of the exclusion device 40 to the building can be carried out by passing nails or screws through the openings 28 in the mounting tabs 26. The outer barbs 30 then will define the part of the exclusion device 10 that is farthest from the building. The intermediate barbs 34 also will be pointing away from the building and will be at a position within the tunnel 52. The outer barbs 30 and the intermediate barbs 34 will exhibit some ability to deflect resiliently outward and will enable an animal that is inside the building to escape outward through the tunnel 52. It is conceivable that an animal that is outside the building could exhibit sufficient strength and dexterity to deflect the outer barbs 34 in an outward direction so that the animal could attempt to re-enter the building. However, the location of the intermediate barbs 34 inside the tunnel 52 will prevent any animal that conceivably could bypass the outer barbs 30 from exerting sufficient leverage to deform the inner barbs 34. As a result, the exclusion device 40 securely prevents an animal from re-entering the building.

The invention has been described with respect to a preferred embodiment. However, changes can be made without departing from the scope of the invention.

1. An exclusion device comprising: a tunnel having opposite first and second ends, mounting tabs formed at the first end of the tunnel and projecting out from the tunnel; outer barbs formed at the second end of the tunnel and bent relative to the tunnel so that the outer barbs converge toward one another at farther distances from the tunnel, the outer barbs being tapered toward ends remote from the tunnel; and intermediate barbs having base ends connected to the tunnel at locations intermediate the first and second ends of the tunnel, each of the intermediate barbs being tapered to narrower dimensions at locations farther from the base end of the respective intermediate barb and at locations closer to the second end of the tunnel, the intermediate barbs being bent inwardly so that the intermediate barbs converge toward one another at ends of the intermediate barbs remote from the base ends of the intermediate barbs.

2. The exclusion device of claim 1, wherein each of the outer barbs has substantially linear side edges converging toward one another.

3. The exclusion device of claim 2, wherein the linear side edges of each of the outer barbs meets at a convexly curved tip.

4. The exclusion device of claim 2, wherein the linear side edges of each of the outer barbs meet at a pointed tip.

5. The exclusion device of claim 2, wherein each of the intermediate barbs align with one of the outer barbs along an extending direction of the tunnel from the first end to the second end.

6. The exclusion device of claim 1, wherein the tunnel has a substantially polygonal cross-section defined by a plurality of side panels, each of the side panels being joined unitarily to at least one other one of the side panels along a fold line extending in an extending direction of the tunnel from the first end to the second end.

7. The exclusion device of claim 6, wherein each of the side panels has one of the outer barbs extending therefrom and one of the intermediate barbs extending therefrom.

8. The exclusion device of claim 7, wherein a plurality of the side panels are formed with first openings at positions between the intermediate barbs and the first end of the tunnel.

9. The exclusion device of claim 8, wherein a plurality of the side panels are formed with second openings at positions between the intermediate barbs and the second end of the tunnel.

10. The exclusion device of claim 8, wherein each of the second openings is on one of the side panels that has one of the first openings, and each of the second openings aligns with one of the first openings on the respective side panel.

11. The exclusion device of claim 6, wherein each of the fold lines has a plurality of slots spaced from one another in end-to end relationship.

12. The exclusion device of claim 1, wherein the tunnel has opposite first and second side edges extending substantially adjacent to one another, side tabs projecting from the first side edge of the tunnel, and slots being formed on the tunnel at positions spaced inward from the second side edge, the slots being disposed in positions aligned with the side tabs and being dimensioned to receive the side tabs for holding the first side edge substantially adjacent to the second side edge.
